(19) United States
(12) Patent Application Publication
(10) Pub. No.: US 2026/0189519 A1
(43) Pub. Date: Jul. 2, 2026

(54) METHOD AND SYSTEM FOR ANSWERING QUESTIONS IN NATURAL LANGUAGE

(71) Applicant: FPT USA CORP., Richardson, TX (US)

(72) Inventors: Khang Thanh Vo NGUYEN, Quy Nhon City (VN); Tung Son NGUYEN, Quy Nhon City (VN)

(73) Assignee: FPT USA CORP., Richardson, TX (US)

(21) Appl. No.: 19/001,972

(22) Filed: Dec. 26, 2024

(51) Int. Cl. H04L 51/02

(52) U.S. Cl. CPC H04L 51/02

(57) ABSTRACT

The present disclosure relates to a method and an apparatus for answering questions in natural language. The method for answering questions in natural language, using a relational database storing image metadata obtained from an artificial intelligence, AI, program, comprises the steps of: receiving a natural language input question in text format; transforming, by a first large language model (LLM1) of a Retrieval-Augmented Generation, RAG, Architecture, the input question into queries with information independence for the database; executing each of the queries with information independence against the database; receiving data in response to the executed queries with information independence; and composing an answer in natural language to the input question from the received data, by a second large language model (LLM2) of a RAG Architecture.

### CROSS-REFERENCE TO RELATED APPLICATIONS

Not Applicable

### TECHNICAL FIELD

The present disclosure relates to the field of artificial intelligence (AI) technology, and in particular, relates to a method and a system for answering questions in natural language.

### BACKGROUND ART

Artificial Intelligence (AI) is a scientific field that is related to building computers as well as machines that can learn, reason and act in such a way that would normally require the intelligence of humans, or that includes data of which the scale goes beyond what humans can analyze. AI is an ability of a machine to replicate or enhance human intelligence, such as learning and reasoning from experiences. AI has been used in computer programs for many years, and is now applied to a variety of other products and services.

As an application, some digital cameras with AI software can extract metadata from the captured images, which in turn can be used for further analysis for applications such as surveillance, data mining, etc. Such metadata, however, has not been exploited successfully for business operations. There exists a need for businesses to utilize the image data from camera systems which are already available in their premises or can be easily purchased for the surveillance of goods, customers, operations, among others. For example, a business owner might have statistical questions regarding one of his retail stores, in a daily, monthly or yearly basis. For example, he might want to know how many customers are in the store at a specific time, how many customers are in the store in a specific period in a day, when the store is most crowded, who entered a specific area of the store and when, in which images a specific person/object appears and when, or the like.

There are some obstacles in order to answer these questions. Firstly, the vast amount of data has limited the ability for the analysis of the data by human manually. Further, the variety of questions makes it almost impossible for human to repeatedly search, analyze and find the answer to a specific question. Secondly, the requirement for the analyzer to be an expert who can discover, study and translate the data in computer language into meaningful information in (human) natural language is a barrier to the understanding of business insights. Hence, there is a lack of a method and a system which can utilize a large amount of image metadata and provide answers in natural language to question, also in natural language.

To this end, some AI software have exhibited a limited capability to summarize the content directly from image sequences or videos in natural language. However, they are defective, for example, if the content is new in comparison to the data they have been trained with, or if the videos do not have sounds as clues on the content. In this regard, the direct processing of image sequences or videos has low efficiency, since the AI software has limited ability to extract information from these images. Further, the data to train the software usually has high volume, and thereby the software consumes many computing resources.

Some other methods tried to answer the questions by classifying them into specific semantic types to re-write the questions in order to understand and find reference materials in a knowledge base. However, the classification has very limited efficiency on multi-component questions, which involves much information to be extracted from the data of the knowledge base.

### SUMMARY

The present disclosure provides a method and system for answering questions in natural language using a database storing image metadata, which can be less demanding on training data and effective with multi-component questions.

To this end, an approach is to use a method based on Retrieval-Augmented Generation (RAG), which combines information retrieval systems with generative large language models (LLM).

According to a first aspect, the present disclosure provides a method for answering questions in natural language, using a relational database storing image metadata obtained from an artificial intelligence, AI, program, the method comprising:
receiving a natural language input question in text format;
transforming, by a large language model (LLM1) of a Retrieval-Augmented Generation, RAG, Architecture, the input question into queries with information independence for the database, the large language model (LLM1) comprises a selector and a decomposer, the transforming comprises:
   providing the decomposer, by the selector, with identifiers of tables and columns to be queried of the database,
      wherein the selector may be pre-trained with the structure of the database and zero, one or more sample questions relating to the subject of the input question as input and zero, one or more respective sample sets of identifiers of the relevant tables and columns as output,
   decomposing, by the decomposer, the input question into multiple queries with information independence, the decomposing comprises:
      converting the input question into multiple related questions with information independence,
         wherein the decomposer may be pre-trained with the structure of the database and zero, one or more sample questions relating to the subject of the input question as input and zero, one or more respective sample sets of related questions with information independence as output,
      transforming each of the related questions with information independence into a corresponding query with information independence, the query with information independence containing one or more identifiers of the tables and columns provided by the selector,
         wherein the decomposer may be pre-trained with the structure of the database and zero, one or more sample questions with information independence relating to the subject of the input question as input and zero, one or more respective corresponding queries with information independence as output;
   executing each of the queries with information independence against the database; receiving data in response to the executed queries with information independence; and composing an answer in natural language to the input question from the received data, by
a large language model (LLM2) of a RAG Architecture,
   wherein the large language model (LLM2) may be pre-trained with the structure of the database and zero, one or more sample questions relating to the subject of the input question as input and zero, one or more respective sample answers in nature language as output.

In a possible implementation, the natural language input question may be input by a user.

In a possible implementation, the image metadata may be obtained from the AI program after the program processed images captured by one or more cameras of a camera system. The AI program may be embedded in one or more cameras of the camera system.

In a possible implementation, the selector may be further pre-trained with restraints to the identifiers of tables and columns to be provided. The restraints may include any one or more of the number of identifiers, the order of the identifiers, and the format of the identifiers.

In a possible implementation, the decomposer may be further pre-trained with restraints to the queries with information independence. The restraints may include the order of statements in the queries.

According to a second aspect, the present disclosure provides a system for answering questions in natural language, using a relational database storing image metadata obtained from an artificial intelligence, AI, program, the system comprising:
a receiver configured to receive a natural language input question in text format;
a Retrieval-Augmented Generation, RAG, Architecture comprising a large language model (LLM1) configured to transform the input question into queries with information independence for the database, the large language model (LLM1) comprises a selector and a decomposer,
   the selector configured to provide the decomposer with identifiers of tables and columns to be queried of the database,
      wherein the selector may be pre-trained with the structure of the database and zero, one or more sample questions relating to the subject of the input question as input and zero, one or more respective sample sets of identifiers of the relevant tables and columns as output,
   the decomposer configured to decompose the input question into multiple queries with information independence, the decomposing comprises:
      converting the input question into multiple related questions with information independence,
         wherein the decomposer may be pre-trained with the structure of the database and zero, one or more sample questions relating to the subject of the input question as input and zero, one or more respective sample sets of related questions with information independence as output,
      transforming each of the related questions with information independence into a corresponding query with information independence, the query with information independence containing one or more identifiers of the tables and columns provided by the selector,
         wherein the decomposer may be pre-trained with the structure of the database and zero, one or more sample questions with information independence relating to the subject of the input question as input and zero, one or more respective corresponding queries with information independence as output;
an executioner configured to execute each of the queries with information independence provided by the LLM1 against the database;
a receiver configured to receive data in response to the executed queries with information independence; and
a large language model (LLM2) of a RAG Architecture configured to compose an answer in natural language to the input question from the received data,
   wherein the large language model (LLM2) may be pre-trained with the structure of the database and zero, one or more sample questions relating to the subject of the input question as input and zero, one or more respective sample answers in nature language as output.

In a possible implementation, the natural language input question may be input by a user.

In a possible implementation, the image metadata may be obtained from the AI program after the program processed images captured by one or more cameras of a camera system. The AI program may be embedded in one or more cameras of the camera system.

In a possible implementation, the selector may be further pre-trained with restraints to the identifiers of tables and columns to be provided. The restraints may include any one or more of the number of identifiers, the order of the identifiers, and the format of the identifiers.

In a possible implementation, the decomposer may be further pre-trained with restraints to the queries with information independence. The restraints may include includes the order of statements in the queries.

According to another aspect, the present disclosure provides a computer program comprising instructions which, upon being executed by a computing device having one or more processors, cause the one or more processors to perform the method according to the first aspect of present disclosure.

According to yet another aspect, the present disclosure provides a computer-readable storage medium having stored thereon a computer program, the computer program comprising instructions which, upon being executed by a computing device having one or more processors, cause the one or more processors to perform the method according to the first aspect of present disclosure.

According to the present disclosure, the method and system for answering questions in natural language can overcome some or all of the above-mentioned limitations, for example, but not limited to, the processing demands less training data and is effective with multi-component questions.

The effects of the present disclosure should not be limited to the above-mentioned effects, and other effects that are not mentioned in the present disclosure will be apparently understood by those skilled in the art from the description and the appended claims.

### BRIEF DESCRIPTION OF DRAWINGS

In the drawings:

FIG. 1 is a schematic diagram illustrating a method for answering questions in natural language according to an embodiment of the present disclosure;

FIG. 2 is a schematic diagram illustrating the step of transforming the input question into queries in FIG. 1, according to an embodiment of the present disclosure;

FIG. 3 is a schematic diagram illustrating the step of decomposing the input question into multiple queries in FIG. 2, according to an embodiment of the present disclosure;

FIG. 4 is a schematic diagram illustrating a system for answering questions in natural language according to an embodiment of the present disclosure; and

FIG. 5 is a schematic diagram illustrating the LLM1 to transform the input question into queries according to an embodiment of the present disclosure.

FIG. 6 is a block diagram illustrating an exemplary computer architecture for implementing aspects of the present disclosure, according to some embodiments of the present disclosure.

### DETAILED DESCRIPTION

Advantages and characteristics of the present disclosure and a method of achieving the same will be made to be clear by referring to exemplary embodiments described in detail below together with the accompanying drawings. However, the present disclosure is not limited to the exemplary embodiments disclosed herein but may be implemented in various forms. The exemplary embodiments are provided by way of example only so that an ordinary skilled in the art can fully understand the present disclosure.

The features of various embodiments of the present disclosure can be partially or entirely combined with each other and can be operated in various ways, and the embodiments can be carried out independently of or in association with one another.

The order of steps or order for performing certain actions is immaterial as long as the present disclosure remains operable. That is, a certain step may occur in an order different from that described herein, or concurrently with another step.

When the terms such as “after,” “subsequent to,” “next to,” “before,” and the like, are used for describing a temporal relationship, cases where any two events are not consecutive or not sequential may be included, unless the term “immediately” or “directly” is explicitly used. That is, one or more other events may occur between those two events, unless a more limiting term such as “just,” “immediate(ly),” or “direct(ly)” is used.

The terms such as “comprising,” “including,” “having,” and “consist of” used herein are generally intended to allow other components to be added unless the terms are used with the term “only”.

Unless otherwise defined, terms used herein (including technical and scientific terms) have common meanings that would normally be interpreted by an ordinary skilled in the art. Further, terms such as those defined in commonly used dictionaries should be interpreted as having a meaning consistent with their meaning in relevant art and should not be interpreted in an idealized or overly formal sense, unless expressly defined otherwise.

Although the terms “first,” “second,” and the like are used for describing various components, these components are not confined by these terms. These terms are merely used for distinguishing one component from the other components. Therefore, a first component to be mentioned below may be a second component in a technical concept of the present disclosure.

Any references to singular may include plural unless expressly stated otherwise. And “a plurality of” means two or more. Further, the phrase “at least one” should be understood as including any and all combinations of one or more of listed items. For example, each of the phrases “at least one of a first item, a second item, or a third item” and “at least one of a first item, a second item, and a third item” may represent a combination of two or more of the first item, the second item, and the third item, or may represent only one of the first item, the second item, or the third item.

Like reference numerals generally denote like elements throughout the specification.

In the following description of the present disclosure, “/” means “or” unless otherwise specified. For example, A/B may represent A or B. In this specification, “and/or” describes only an association relationship for describing associated objects and represents that three relationships may exist. For example, A and/or B may represent the following three cases: Only A exists, both A and B exist, and only B exists.

In the following description of the present disclosure, a detailed explanation of known related technologies may be omitted to avoid unnecessarily obscuring the subject-matter of the present disclosure.

The present disclosure will now be described with reference to the accompany drawings.

To overcome the low efficiency of directly analyzing image sequences or videos, the present disclosure provides a method using image metadata from a relational database. The metadata is obtained from an AI program which is capable to analyze the images captured by one or more cameras in a camera system and extract data in a form suitable to be stored in a relational database. That is, the metadata is stored in the forms of columns in tables in a relational database. The columns contain values for properties of the corresponding table, whereas each table represents a meaningful object in the one or more images captured by the one or more cameras. For example, there can be a table for “Customers” where the data on various customers, a table for “Products” where the data on various products of a retail store, a table for “CustomerVisit” where the data on the visits of customers to a retail store, a table for “Employee” where the data about each employee in a factory, a table for “Departments” where the data about constituting departments of a factory, etc. are readily stored for information retrieval. In one embodiment, the images are captured by one or more cameras and then processed by the AI program to provide metadata, which in turn is stored in the database. In a further embodiment, the AI program can be embedded into one or more cameras of the camera system, while the images from other cameras are sent to the AI program external to the cameras to be processed.

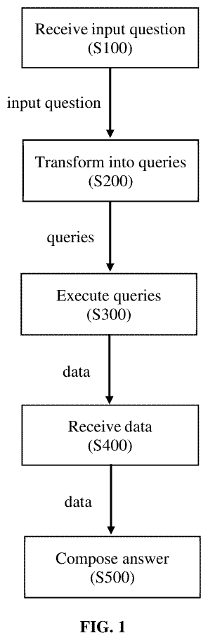

FIG. 1 is a schematic diagram illustrating a method for answering questions in natural language according to one embodiment of the present disclosure. In FIG. 1, an input question in national language is received (S100). This can be done by a user inputting the question into a receiver 1, such as a text box on an interface of a software. The input question may be in a form of a statistical inquiry, in which the information regarding a business is requested, for example, “When is the period of time in 19 August that the store is most crowded?”.

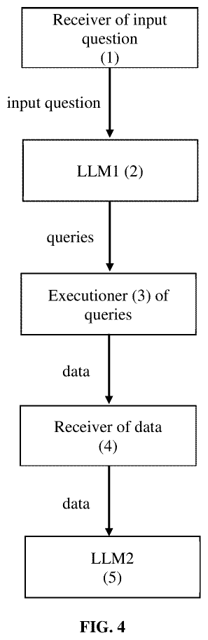

As shown in FIG. 4, the input question is forwarded by the receiver 1 to a large language model (LLM), the LLM1, where it is transformed into queries readily to be executed against the relational database (S200). In an embodiment, the LLM1 can implement the retrieval component of a Retrieval-Augmented Generation, RAG, Architecture.

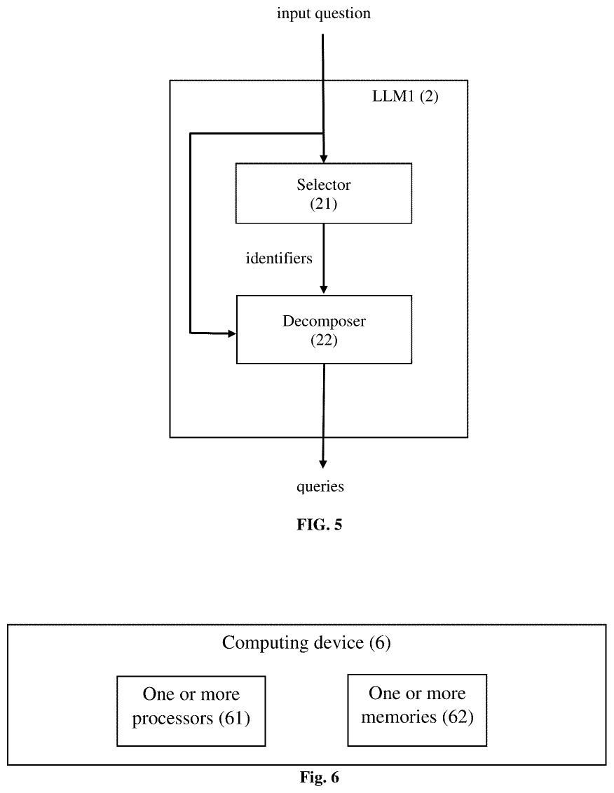

Referring to FIG. 5, the LLM1 comprises a selector 21 and a decomposer 22.

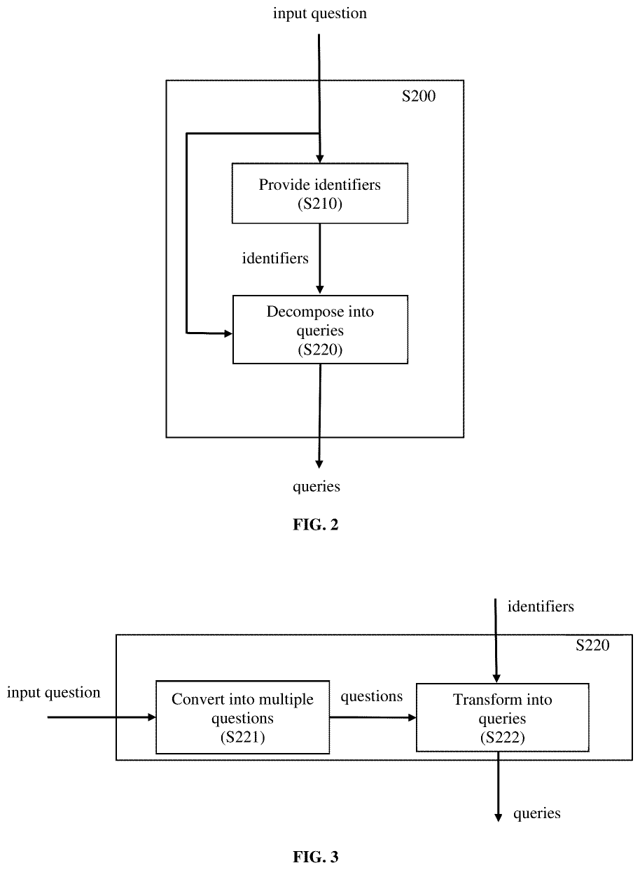

Referring to FIG. 2, the selector may be configured to receive the input question, and provide the identifiers of one or more tables and/or the identifiers of one or more columns in the database, in which these tables and columns are relevant to the input question (S210).

To this end, in one embodiment, the LLM1, in particular, the selector, may be pre-trained with the structure of the database and zero, one or more sample questions relating to the subject of the input question as input and zero, one or more respective sample sets of identifiers of the relevant tables and columns as output.

For example, the structure of the database may include the name of the database, the tables in the database and/or their identifiers, the columns in each table and/or their identifiers, and the relationship between the tables, as conventionally defined in a relational database. For example, a many-to-many relationship between a “Product” table and a “Customers” table indicates that a customer may have purchased many products, and a product may have been purchased by many customers. The structure of the database can be provided in the form of a prompt to the selector which describes it in text or any appropriate format, depending on the LLM.

The sample questions are questions in natural language, similar to the input question, that are used as a suggestion for the selector which identifier should be returned if the input question is provided. Therefore, these questions can be related to the subject of the input question. For example, in case the question is “When is the period of time in 19 August that the store is most crowded?”, a sample question may be “What day is the most crowed day in the store this month?” or the like. The sample questions can be provided in the form of a prompt to the selector which describes it in text or any appropriate format, depending on the LLM.

In correspondence with these questions, the selector is also trained with the sets of identifiers of the relevant tables and columns that should be returned if these questions are asked. For example, in case the of the question “What day is the most crowed day in the store this month?”, the identifiers of the tables “CustomerVisit” which stores the data on the visits of customers to the store (for example, their IDs (column “PersonID”), the time they entered the store (column “TimeIn”), the time they left (column “TimeOut”), and the ID of the store (column “StoreID”), etc.) should be returned. In an example, there is one set of identifiers for each sample question. The sample sets of identifiers can be provided in the form of a prompt to the selector which describes it in text or any appropriate format, depending on the LLM.

In an embodiment, there can be zero (0) sample question and zero (0) sample set of identifiers used for pre-training the selector, that is, the selector might not require training data. In an embodiment, only one sample question and one sample set of identifiers are used for pre-training the selector. By using the number of training data of zero, one or a limited number of sample questions and sample sets of identifiers, the volume of training data can be controlled not to be excessive or resource-consuming, and thereby the training time and cost can be reduced.

In an embodiment, the selector may be further pre-trained with restraints to the identifiers of tables and columns to be provided. These restraints are used to impose some requirements on the identifiers. For example, if it may be required for the selector to provide the decomposer with at least 3 identifiers, e.g., 3 table identifiers, to make sure that LLM2 described below will receive enough data to compose the answer to the input question, a restraint, in this case, on the number of identifier (i.e., 3) can be used for pre-training the selector. In another example, a restraint can be the order of the identifiers to be provided to the decomposer, so that the answer to the input question may have a particular order of presented information, for example. In yet another example, a restraint can be the format of the identifier, to conform to a data standard for subsequent processing, such as JSON (JavaScript Object Notation). The restraints can be provided in the form of a prompt to the selector which describes it in text or any appropriate format, depending on the LLM.

The decomposer is configured to receive the input question and the identifiers provided by the selector, and decompose the input question into multiple queries with information independence (S220).

As shown in FIG. 3, to achieve this, in one embodiment, the decomposer may firstly convert the input question into multiple questions with information independence from each other (S221). The principle for the convert is that the input questions are divided into smaller questions according to the principle of information independence-that is, each question should only depend on a certain part of data in the database, the information is divided such that the complexity and the amount of target data of the question is reduced. Some examples of the smaller questions, which focus to an independent information might include a question on the amount or count (e.g., the number of customers who invited the store), a question on time or time period (e.g., the time a customer stayed in the store), a question on the type or property of an object (e.g., the object is customer and the type is male or female), etc. Here, a person skilled in the art of artificial intelligence will understand that information independence in a multi-component question is the degree of semantic and content separation of each component, assessed through a large language model (i.e., the LLM1) based on the semantic similarity, logical relationship, and information overlap, etc. It is based on the assumption that the components with high information independence can be separated into separate questions and have separate answers from other components. The following evaluation criteria can be specified in the LLM and the LLM, based on the evaluation, may automatically determine to split the input questions into smaller questions (questions with information independence): (1) Semantic similarity: whether the questions are semantically similar, (2) Logical relationship: whether the questions are logically linked, for example, whether point B can be deduced from point A and (3) Information overlap: whether the questions have overlap information that may lead to an answer. Based on these estimations, which can be measured, for example, on a scale of 0 to 1, the information independence can be determined by a weighted sum. For example, Similarity score=Semantic similarity score * 40%+Logical relationship score * 30%+Information overlap score*30%. The LLM can, for example, determine that two questions are not similar (having information independence) if they have the Similarity score less than 0.7, and are similar (not having information independence) if they have the Similarity score more than or equal to 0.7. Of course, these are just examples, and the information independence can be determined based on other criteria and weighted sum, or any other measurement as appropriate can be used, and the present disclosure is not limited thereto, as long as the LLM, in particular the decomposer, can automatically convert an input question into multiple questions with information independence.

In one embodiment, the decomposer may be pre-trained with the structure of the database and zero, one or more sample questions relating to the subject of the input question as input and zero, one or more respective sample sets of related questions with information independence as output.

For example, the structure of the database and the sample questions may be the same as or similar to those used to pre-train the selector. Therefore, the description of the structure of the database and the sample questions will be omitted to avoid redundancy to the description. In correspondence with these sample questions, the decomposer is also trained with the sets of related questions with information independence that should be returned if these questions are asked. For example, in case the of the question “What day is the most crowed day in the store this month?”, the sample set of related questions “What is this month?”, “What is the number of customers visited the store in each day of this month?”, “What number is the highest in these numbers?” etc. can be used. In an example, there is one set of related questions for each sample question. The set of related questions can be provided in the form of a prompt to the decomposer which describes it in text or any appropriate format, depending on the LLM.

In an embodiment, there can be zero (0) sample question and zero (0) sample set of related questions used for pre-training the decomposer, that is, the decomposer might not require training data. In an embodiment, only one sample question and one sample set of related questions are used for pre-training the decomposer. By using the number of training data of zero, one or a limited number of sample questions and sample sets of related questions, the volume of training data can be controlled not to be excessive or resource-consuming, and thereby the training time and cost can be reduced.

Still referring to FIG. 3, the decomposer may transform each of the related questions with information independence into a corresponding query with information independence, the query containing one or more identifiers of the tables and columns provided by the selector (S222).

To this end, in one embodiment, the LLM1, in particular, the decomposer, may be pre-trained with the structure of the database and zero, one or more sample questions with information independence relating to the subject of the input question as input and zero, one or more respective corresponding queries with information independence as output. The description above on information independence can be applied similarly here, and the redundant description will be omitted. In an example, the structure of the database and the sample questions with information independence may be the same as or similar to those used to pre-train the decomposer for the converting describe-above. Therefore, the description of the structure of the database and the sample questions with information independence will be omitted to avoid redundancy to the description. In correspondence with these sample questions with information independence, the decomposer is also trained with the sets of queries with information independence that should be returned if these questions are provided. For example, in case the of the question “What is this month?”, “What is the number of customers visited the store in each day of this month?”, “What number is the highest in these numbers?” the sample queries, e.g. in SQL (structured query language), “SELECT EXTRACT(MONTH FROM CURRENT_DATE) AS current_month;”, “SELECT DATE(TimeIn) AS VisitDate, COUNT(PersonID) AS NumVisits FROM CustomerVisit WHERE EXTRACT(MONTH FROM TimeIn)=EXTRACT(MONTH FROM CURRENT_DATE) GROUP BY DATE(TimeIn) ORDER BY VisitDate;”, “SELECT MAX(NumVisits) AS MaxVisits FROM (SELECT DATE(TimeIn) AS VisitDate, COUNT(PersonID) AS NumVisits FROM CustomerVisit WHERE EXTRACT(MONTH FROM TimeIn)=EXTRACT(MONTH FROM CURRENT_DATE) GROUP BY DATE(TimeIn)) AS DailyVisits;” should be returned, respectively. In an example, there is one sample query for each sample question. The sample queries can be provided in the form of a prompt to the decomposer which describes it in text or any appropriate format, depending on the LLM.

In an embodiment, there can be zero (0) sample question and zero (0) sample query used for pre-training the decomposer, that is, the decomposer might not require training data. In an embodiment, only one sample question and one sample query are used for pre-training the decomposer. By using the number of training data of zero, one or a limited number of sample questions and sample queries, the volume of training data can be controlled not to be excessive or resource-consuming, and thereby the training time and cost can be reduced.

In one embodiment, the decomposer may check whether each query contains one or more identifiers of the tables and columns provided by the selector, and does not contain other identifiers, to ensure that it is eligible for execution.

In an embodiment, wherein the decomposer may be further pre-trained with restraints to the queries. These restraints are used to impose some requirements on the queries to be output by the decomposer. In some cases, some query can be optimized if it follows a particular sequence of statement, for example, a combination statement (e.g., a JOIN statement in SQL) precedes a selection statement (e.g., a SELECT statement in SQL), or a classification statement (e.g., GROUP BY statement in SQL) precedes a sorting statement (e.g., an ORDER BY statement in SQL). Therefore, a restraint on the order of statements in the queries can be used to pre-train the decomposer. The restraints can be provided in the form of a prompt to the decomposer which describes it in text or any appropriate format, depending on the LLM.

Referring back to FIG. 1 and FIG. 4, the queries are forwarded by the LLM1 to an executioner, where they are executed against the database (S300). For example, the executioner can be a component of a database management system which is capable of compiling the queries to extract and retrieve data from the database, or the like.

Still referring to FIG. 4, the system may comprise a receiver 4, which receives the data returned by the executed queries (S400). As an example, the receiver 4 can be a separate component or, in one embodiment, can be included in the executioner, or in another embodiment, included in the LLM2 described-below. As the result, the received data can be the input of the LLM2.

As shown in FIG. 4, the LLM2 may receive the data from the receiver 4 and, based on the data, compose an answer in natural language to the input question (S500). In an embodiment, the LLM2 can implement the generative component of a Retrieval-Augmented Generation, RAG, Architecture. The answer can be in text or any suitable format, such as voice, depending on the LLM.

In one embodiment, the LLM2 may be pre-trained with the structure of the database and zero, one or more sample questions relating to the subject of the input question as input and zero, one or more respective sample answers in nature language as output.

For example, the structure of the database and the sample questions may be the same as or similar to those used to pre-train the selector. Therefore, the description of the structure of the database and the sample questions will be omitted to avoid redundancy to the description. In correspondence with these sample questions, the LLM2 is also trained with the sample answers, in natural language, that should be returned if these questions are asked. For example, in case of the question “What day is the most crowed day in the store this month?”, the sample answer “The most crowded day in this month is the 12th” or the like can be used. In an example, there is one sample answer for each sample question. The sample answers can be provided in the form of a prompt to the LLM2 which describes it in text or any appropriate format, depending on the LLM.

In an embodiment, there can be zero (0) sample question and zero (0) sample answer used for pre-training the LLM2, that is, the LLM2 might not require training data. In an embodiment, only one sample question and one sample answer are used for pre-training the LLM2. By using the number of training data of zero, one or a limited number of sample questions and sample answers, the volume of training data can be controlled not to be excessive or resource-consuming, and thereby the training time and cost can be reduced.

It should be noted that the large language models LLM1 and LLM2 mentioned above can be two separate large language models, or they can be combined into one large language model, with no specific limitation. Each large language model may be a customized model of a common large language model, such as ChatGPT, Llama, Google Gemini, MS Copilot, Claude, or the like.

Although an SQL-based database and SQL queries have been used throughout the present disclosure, this is merely an example of a relational database. Other databases, such as MariaDB and Oracle Database, or any suitable relational database can also be used, without limitation.

The present disclosure also provides a computer program, the computer program comprises instructions which, upon being executed by a computing device having one or more processors, cause the one or more processors to perform the method in any of or any combination of possible implementations in the foregoing method embodiments.

The present disclosure also provides a computer-readable storage medium having stored thereon a computer program, the computer program comprises instructions which, upon being executed by a computing device having one or more processors, cause the one or more processors to perform the method in any of or any combination of possible implementations in the foregoing method embodiments.

FIG. 6 is a block diagram illustrating an exemplary computer architecture for implementing aspects of the present disclosure, according to some embodiments of the present disclosure.

Referring to FIG. 6, an exemplary computer architecture may include a computing device 6 (for example, but not limited to, a general-purpose computing device). The computing device 6 may include one or more processors 61, one or more memories 62 and/or any other units. The one or more processors 61 may be, but not limited to, a general-purpose processor, an application-specific integrated circuit (ASIC), or a field-programmable gate array (FPGA). The one or more memories 62 may be, but not limited to, a non-volatile memory such as a hard disk drive (HDD), or a volatile memory such as a random-access memory (RAM). The one or more memories 62 are configured to store instructions and data. The one or more memories 62 are coupled to the one or more processors 61. In embodiments of the present disclosure, a computer program comprises instructions which, upon being executed by the computing device 6, cause the one or more processors 61 to perform the method in any of or any combination of possible implementations in the foregoing method embodiments. In other embodiments of the present disclosure, a computer-readable storage medium stores a computer program, the computer program comprises instructions which, upon being executed by the computing device 6, cause the one or more processors 61 to perform the method in any of or any combination of possible implementations in the foregoing method embodiments.

All or some of the foregoing embodiments may be implemented by software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, all or of the procedures or functions are generated according to the embodiments of the present disclosure. The computer may be a general-purpose computer, a computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, microwave, or the like) manner. The computer-readable storage medium may be any usable medium accessible by a computer, or a data storage device, a server or a data center, integrating one or more usable media. The usable medium may be a magnetic medium (for example, a floppy disk, a hard disk, a magnetic tape), an optical medium (for example, a DVD), a semiconductor medium (for example, a solid-state drive), or the like.

The foregoing descriptions are merely specific implementations of this application, but are not intended to limit the protection scope of this application. An ordinary skilled in the art can make modifications/changes/substitutions to the foregoing embodiments without departing from the technical scheme of the present disclosure. Any variation or replacement readily figured out by a person skilled in the art within the technical scope disclosed in this application shall fall within the protection scope of this application. Therefore, the protection scope of this application shall be subject to the protection scope of the claims.

I/we claim:

1. A method for answering questions in natural language, using a relational database storing image metadata obtained from an artificial intelligence, AI, program, the method comprising:
receiving a natural language input question in text format;
transforming, by a first large language model (LLM1) of a Retrieval-Augmented Generation, RAG, Architecture, the input question into queries with information independence for the database, the first large language model (LLM1) comprises a selector and a decomposer, the transforming comprises:
providing the decomposer, by the selector, with identifiers of tables and columns to be queried of the database,
wherein the selector is pre-trained with the structure of the database and zero, one or more sample questions relating to the subject of the input question as input and zero, one or more respective sample sets of identifiers of the relevant tables and columns as output,
decomposing, by the decomposer, the input question into multiple queries with information independence, the decomposing comprises:
converting the input question into multiple related questions with information independence,
wherein the decomposer is pre-trained with the structure of the database and zero, one or more sample questions relating to the subject of the input question as input and zero, one or more respective sample sets of related questions with information independence as output,
transforming each of the related questions with information independence into a corresponding query with information independence, the query with information independence containing one or more identifiers of the tables and columns provided by the selector,
wherein the decomposer is pre-trained with the structure of the database and zero, one or more sample questions with information independence relating to the subject of the input question as input and zero, one or more respective corresponding queries with information independence as output;
executing each of the queries with information independence against the database; receiving data in response to the executed queries with information independence; and
composing an answer in natural language to the input question from the received data, by a second large language model (LLM2) of a RAG Architecture,
wherein the second large language model (LLM2) is pre-trained with the structure of the database and zero, one or more sample questions relating to the subject of the input question as input and zero, one or more respective sample answers in nature language as output.

2. The method of claim 1, wherein the natural language input question is input by a user.

3. The method of claim 1,
wherein the image metadata is obtained from the AI program after the program processed images captured by one or more cameras of a camera system.

4. The method of claim 3,
where in the AI program is embedded in one or more cameras of the camera system.

5. The method of claim 1,
wherein the selector is further pre-trained with restraints to the identifiers of tables and columns to be provided.

6. The method of claim 5,
wherein the restraints include any one or more of the number of identifiers, the order of the identifiers, and the format of the identifiers.

7. The method of claim 1,
wherein the decomposer is further pre-trained with restraints to the queries with information independence.

8. The method of claim 7,
wherein the restraints include the order of statements in the queries.

9. A system for answering questions in natural language, using a relational database storing image metadata obtained from an artificial intelligence, AI, program, the system comprising:
a receiver configured to receive a natural language input question in text format;
a Retrieval-Augmented Generation, RAG, Architecture comprising a first large language model (LLM1) configured to transform the input question into queries with information independence for the database, the first large language model (LLM1) comprises a selector and a decomposer,
the selector configured to provide the decomposer with identifiers of tables and columns to be queried of the database,
wherein the selector is pre-trained with the structure of the database and zero, one or more sample questions relating to the subject of the input question as input and zero, one or more respective sample sets of identifiers of the relevant tables and columns as output,
the decomposer configured to decompose the input question into multiple queries with information independence, the decomposing comprises:
converting the input question into multiple related questions with information independence,
wherein the decomposer is pre-trained with the structure of the database and zero, one or more sample questions relating to the subject of the input question as input and zero, one or more respective sample sets of related questions with information independence as output,
transforming each of the related questions with information independence into a corresponding query with information independence, the query with information independence containing one or more identifiers of the tables and columns provided by the selector,
wherein the decomposer is pre-trained with the structure of the database and zero, one or more sample questions with information independence relating to the subject of the input question as input and zero, one or more respective corresponding queries with information independence as output;
an executioner configured to execute each of the queries with information independence provided by the LLM1 against the database;
a receiver configured to receive data in response to the executed queries with information independence; and
a second large language model (LLM2) of a RAG Architecture configured to compose an answer in natural language to the input question from the received data,
wherein the second large language model (LLM2) is pre-trained with the structure of the database and zero, one or more sample questions relating to the subject of the input question as input and zero, one or more respective sample answers in nature language as output.

10. The system of claim 9, wherein the natural language input question is input by a user.

11. The system of claim 9,
wherein the image metadata is obtained from the AI program after the program processed images captured by one or more cameras of a camera system.

12. The method of claim 11,
where in the AI program is embedded in one or more cameras of the camera system.

13. The system of claim 9,
wherein the selector is further pre-trained with restraints to the identifiers of tables and columns to be provided.

14. The system of claim 13,
wherein the restraints include any one or more of the number of identifiers, the order of the identifiers, and the format of the identifiers.

15. The system of claim 9,
wherein the decomposer is further pre-trained with restraints to the queries with information independence.

16. The system of claim 15,
wherein the restraints include the order of statements in the queries.

17. A computer program comprising instructions which, upon being executed by a computing device having one or more processors, cause the one or more processors to perform the method according to claim 1.
